(19) United States
(12) Patent Application Publication
(10) Pub. No.: US 2025/0172440 A1
(43) Pub. Date: May 29, 2025

(54) NTC THERMISTOR COMPOSITION AND THERMISTOR ELEMENT

(71) Applicant: TDK Corporation, Tokyo (JP)

(72) Inventors: Tetsu SYOJI, Tokyo (JP); Yosuke HOSHIKAWA, Tokyo (JP)

(73) Assignee: TDK Corporation, Tokyo (JP)

(21) Appl. No.: 18/918,481

(22) Filed: Oct. 17, 2024

(30) Foreign Application Priority Data
Nov. 28, 2023 (JP) 2023-200934

(51) Int. Cl. G01K 7/22; C22C 22/00

(52) U.S. Cl. CPC G01K 7/22; C22C 22/00

(57) ABSTRACT

An NTC thermistor composition contains 40 to 63 mol % of Mn, 10 to 30 mol % of Co; 15 to 35 mol % of Ni, and 5.9 mol % or less (including 0) of Al.

### BACKGROUND OF THE DISCLOSURE

The present invention relates to an NTC thermistor composition and a thermistor element including thermistor layers composed of the composition.

Negative temperature coefficient (NTC) thermistor elements have a characteristic that the resistance value decreases as the temperature increases and are used in various devices, such as electronic devices, as temperature sensors, temperature compensation elements, or the like. Since devices in which such thermistor elements are mounted are used in various environments, the thermistor elements are required to have a high reliability. Specifically, thermistor elements are required to have a small resistance change rate even in a high-temperature and high-humidity atmosphere of 120° C. or more. For example, thermistor elements having the composition shown in Patent Document 1 below are now developed.

The thermistor elements having the composition shown in Patent Document 1 are suitable as a thermistor composition for use in, for example, glass diode type thermistors, glass bead type thermistors, or resin bead type thermistors.
Patent Document 1: JP2009188179 (A)

### BRIEF SUMMARY OF THE INVENTION

Although multilayer chip-type thermistor elements are also developed nowadays, the present inventors have found that the characteristics of multilayer thermistor elements change significantly depending on the composition before and after the thermistor elements are mounted on circuit boards, etc. of various electronic devices.

The present invention has been made in view of the above circumstances. It is an object of the invention is to provide: an NTC thermistor composition capable of realizing an NTC thermistor element with excellent thermal stability against heat during reflow processing and small variation in resistance value; and a thermistor element including the composition.

To achieve the above object, an NTC thermistor composition according to an aspect of the present invention comprises:
40 to 63 mol % of Mn;
10 to 30 mol % of Co;
15 to 35 mol % of Ni; and
5.9 mol % or less (including 0) of Al,
where a total of Mn, Co, Ni, and Al is 100 mol %.

The present inventors have conducted extensive research into NTC thermistor compositions. As a result, the present inventors have found that an NTC thermistor element with excellent thermal stability against heat during reflow processing and small variation in resistance value can be realized by containing Mn, Co, and Ni within a predetermined range and have completed the present invention.

The NTC thermistor composition may further comprise 0 to 2.5 mol % of Zr.

Preferably, Ni is contained more than Co. In this configuration, the thermal stability is improved, and the variation in resistance value is further reduced.

Preferably, Fe or Cu is not substantially contained. If either of them is substantially contained in the composition, the thermal stability tends to decrease, and the variation in resistance value tends to increase. Note that, “not substantially contained” means that Fe or Cu may be contained to the extent that: the thermal stability is not significantly impaired; and the variation in resistance value is not significantly increased. For example, Fe or Cu may be contained in the composition within 0.5 mol %.

Preferably, the composition comprises spinel-type metal oxide particles having an average particle size of 10 μm or less. This configuration has the following advantages: the density of the composition is improved; the thermal stability is further improved; the variation in resistance value is further reduced; shrinkage of inner electrodes can be easily controlled because the firing temperature can be lowered; and the variation in resistance value can be reduced.

An NTC thermistor element according to an aspect of the present invention comprises any of the above-described NTC thermistor compositions. According to the NTC thermistor element, even if multiple reflow processing are performed at the time of mounting this element on a circuit board, etc., the change in characteristics is small, the thermal stability is excellent, and the variation in resistance value is small.

Preferably, the size of the element is 0.6 mm or less in a first axis direction and 0.3 mm or less in a second axis direction.

### BRIEF DESCRIPTION OF THE SEVERAL VIEWS OF THE DRAWING

FIG. 1 is a schematic cross-sectional view of an NTC thermistor element according to an embodiment of the present invention; and

FIG. 2 is a graph showing a resistance change rate of each element according to Example of the present invention and Comparative Examples.

### DETAILED DESCRIPTION OF THE INVENTION

Hereinafter, an embodiment is described with reference to the figures. In the figures, the X-axis, the Y-axis, and the Z-axis are perpendicular to each other.

### Thermistor Element

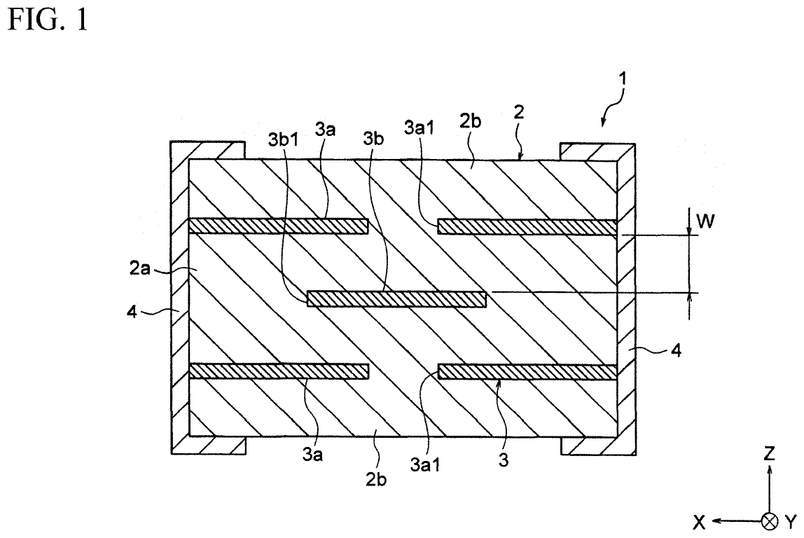

As shown in FIG. 1, an NTC thermistor element 1 according to the present embodiment includes an element body 2 and external electrodes 4 and 4 provided on both ends of the element body 2 in the X-axis direction. In the inside of the element body 2, internal electrode layers 3 are laminated at predetermined intervals along the Z-axis direction so as to sandwich a thermistor layer 2a, and protective layers 2b are laminated on the outside of the internal electrode layers located outermost along the Z-axis.

The internal electrode layers 3 include a pair of first internal electrode layers 3a with a first predetermined pattern and a second internal electrode 3b with a second predetermined pattern located therebetween, both of which are continuous along the Y-axis in the pattern shown in FIG. 1 and are partially interrupted along the X-axis. Each of the first internal electrode layers 3a is provided with an interrupted portion 3al formed at a substantially central part along the X-axis so as to interrupt electrical conduction between the first internal electrode layer 3a located on both sides, and the first internal electrode layer 3a located on both sides of the interrupted portion 3al along the X-axis is connected to each of the external electrodes 4 and 4. In the interrupted portions 3a1, the thermistor layers 2a and the protective layers 2b are continuous.

The second internal electrode layer 3b located between the pair of first internal electrode layers 3a and 3a along the Z-axis is provided with a pair of interrupted portions 3b1 formed at positions close to the external electrodes 4 and 4 along the X-axis so as to interrupt electrical conduction between the second internal electrode layer 3b with an isolated pattern located approximately at the center and both of the external electrodes 4 and 4. At the interrupted portions 3b1, two thermistor layers 2a are continuous.

The width along the X-axis of the second internal electrode layer 3b with an isolated pattern located at the center along the X-axis is larger than the width of each of the interrupted portions 3al of the first internal electrode layers 3a. Moreover, when viewed from the direction along the Z-axis, the second internal electrode layer 3b with an isolated pattern located at the center along the X-axis overlaps with the first internal electrode layers 3a located on both sides along the X-axis, and the portions of the thermistor layers 2a located at the overlapping portion are active layers of the thermistor layers. Note that, the number of layers and the pattern shape of the internal electrode layers 3a and 3b are not limited to the examples shown in FIG. 1 and are not limited as long as a thermistor circuit is formed.

In the present embodiment, the thermistor layers 2a and the protective layers 2b are preferably made of the same thermistor composition, but the protective layers 2b have almost no effect on the characteristics of the thermistor element and may thus be made of an insulating material composition different from that of the thermistor layers 2a. In the present embodiment, the thermistor layers 2a are made of an NTC thermistor composition described below.

Preferably, the first internal electrode layers 3a and the second internal electrode layer 3b contain a noble metal element as a conductive component. The noble metal element contained in the internal electrodes is not limited and may include one or more elements selected from the group consisting of Pd, Ag, and Pt. In addition to the above-mentioned noble metal elements, the internal electrode layers 3a and 3b may contain base metal elements, such as Ni and Cu, as a conductive component.

Preferably, the external electrodes 4 contain a noble metal element as a conductive component. The noble metal element contained in the external electrodes 4 is not limited and may include one or more elements selected from the group consisting of Pd, Ag, and Pt. In addition to the above-mentioned noble metal elements, the external electrodes 4 may contain a base metal element, such as Ni and Cu, as a conductive component. In addition to the above-mentioned metal elements, the external electrodes 4 may contain a glass component. The glass component is added so as to promote sintering of the external electrodes 4 and to provide the external electrodes with mechanical strength. The composition of the external electrodes 4 is not limited and may include, for example, a metal component in an amount of 60% by volume or more and 95% by volume or less and a glass component in an amount of 5% by volume or more and 40% by volume or less. The composition of the glass component contained in the external electrodes is not limited and may be appropriately determined according to the intended use. The glass component contained in the external electrodes may include, for example, at least one selected from the group consisting of alkaline earth metals, Cu, Si, Ti, Zn, alkali metals, Sr, Al, and Bi.

The size of the NTC thermistor element 1 according to the present embodiment is not limited, but is preferably 0.6 mm or less along the X-axis direction, 0.3 mm or less along the Y-axis, and 0.3 mm or less along the Z-axis. The thickness of each of thermistor layers 2a is not limited, but is preferably 5 to 100 μm.

In the present embodiment, the thermistor layers 2a are made of an NTC thermistor composition and preferably contain spinel-type metal oxide particles having an average particle size of 10 μm or less, and these particles are arranged in the thermistor layers 2a at a predetermined density. When the oxide particles have an average particle size of 10 μm or less, the density of a fired body is improved, and the thermal stability is increased. Note that, the method for controlling the average particle size of the oxide particles to 10 μm or less is not limited and, for example, the average particle size is adjusted by passing a ceramic slurry through a mesh.

Whether or not the thermistor layers 2a contain spinel-type metal oxide particles can be determined by analyzing the thermistor layers 2a, for example, by X-ray diffraction. Also, an average particle size of the metal oxide particles can be determined by observing a cross section of the thermistor layer 2a, for example, by a scanning electron microscope and averaging the particle sizes of 100 or more particles. Also, a density of the metal oxide, for example, a percentage of particles per 100 square micrometers can be analyzed by observing a cross section of the thermistor layer 2a in a similar manner. In addition to the metal oxide particles, the thermistor layers 2a may contain segregated particles, etc., but the percentage of segregated particles, etc. in the area of the cross section is preferably 5% or less.

In the present embodiment, the metal contained in the NTC thermistor composition constituting the thermistor layers 2a includes at least Mn, Co, and Ni and may include Al and Zr as necessary and preferably does not substantially include Fe or Cu.

In the present embodiment, the Mn content is 40 to 63 mol %, preferably 47 to 60 mol %, where the total of Mn, Co, Ni, and Al is 100 mol %. When the Mn content is within a predetermined range, the resistance change rate is low, and the coefficient of variation of resistance value is also low. The reason for this is believed to be that if the Mn content is too low, self-heating tends to increase, making it difficult to use as an NTC thermistor element, and if the Mn content is too high, structural stability tends to decrease and thermal stability tends to decrease.

Note that, the resistance change rate refers to a rate of change in resistance before and after an NTC thermistor element including the NTC thermistor composition according to the present embodiment is passed through a reflow furnace several times. Also, the coefficient of variation of resistance value refers to a variation in resistance at 25° C. between a plurality of NTC thermistor elements including the NTC thermistor composition according to the present embodiment. The smaller the coefficient is, the smaller the variation between individual elements is.

The Co content is 10 to 30 mol %, preferably 13 to 25 mol %, and more preferably 15 to 23 mol %. When the Co content is within a predetermined range, the resistance change rate is low, and the coefficient of variation of resistance value is also low. The reason for this is believed to be that if the Co content is too low, the structural stability tends to decrease and the thermal stability tends to decrease, and if the Co content is too high, Co tends to be unable to form a solid solution and to precipitate as a different phase, and the variation in resistance value tends to increase.

The Ni content is 15 to 35 mol %, preferably 17 to 31 mol %, and more preferably 21 to 27 mol %. When the Ni content is within a predetermined range, the resistance change rate is low, and the coefficient of variation of resistance value is also low. The reason for this is believed to be that if the Ni content is too low, the structural stability tends to decrease and the thermal stability tends to decrease, and if the Ni content is too high, Ni tends to be unable to form a solid solution and to precipitate as a different phase, and the variation in resistance value tends to increase.

In the composition, Al may not be contained, but may be contained. When Al is contained, the Al content is 5.9 mol % or less. When the Al content is within a predetermined range, the resistance change rate is low, and the coefficient of variation of resistance value is also low. The reason for this is believed to be that if the Al content is too high, Al tends to be unable to form a solid solution and to precipitate as a different phase, and the variation in resistance value tends to increase. Note that, compared to when Al is not contained, containing Al is advantageous in that the structural stability tends to improve and the thermal stability tends to be high, and in that respect, the Al content is preferably 1.9 to 4.8 mol %.

Preferably, the Ni content is higher than the Co content. In this configuration, the resistance change rate is low, and the coefficient of variation of resistance value is also low. The reason for this is believed to be that the valence fluctuation is reduced, and the thermal stability is improved. Also, when the Ni content is higher than the Co content, lower production costs can be expected.

In the composition, Zr may not be contained, but may be contained. When Zr is contained, the Zr content is 2.5 mol % or less. When the Zr content is within a predetermined range, the resistance change rate is low, and the coefficient of variation of resistance value is also low. The reason for this is believed to be that the valence fluctuation is reduced, and the thermal stability is improved.

In the NTC thermistor composition according to the present embodiment, preferably, Fe is not substantially contained. When Fe is not substantially contained, the resistance change rate is low, and the coefficient of variation of resistance value is also low. The reason for this is that when Fe is substantially contained, the variation in resistance value becomes large. Note that, “not substantially contained” means that Fe may be contained to the extent that the inherent characteristics of the NTC thermistor composition according to the present embodiment are not impaired, and Fe may be contained in an amount of about 0.5 mol % or less.

In the NTC thermistor composition according to the present embodiment, preferably, Cu is not substantially contained. When Cu is not substantially contained, the resistance change rate is low, and the coefficient of variation of resistance value is also low. The reason for this is that when Cu is substantially contained, the variation in resistance value tends to become large. Note that, “not substantially contained” means that Cu may be contained to the extent that the inherent characteristics of the NTC thermistor composition according to the present embodiment are not impaired, and Cu may be contained in an amount of about 0.5 mol % or less.

As other metal components, the NTC thermistor composition according to the present embodiment may contain metals, such as Ba, Ca, Mo, Nb, Sn, Ti, V, W, and Y, in an amount of about 0.5 mol % or less. Other metals may be contained to the extent that the inherent characteristics of the NTC thermistor composition according to the present embodiment are not impaired.

In the thermistor element 1 of the present embodiment, since the thermistor layers 2a are made of the above-mentioned composition, even if the element 1 is miniaturized, the thermal stability against heat during reflow processing is excellent, and the variation in resistance value is small. The heat during reflow processing is, for example, a temperature of 200° C. or more. The number of reflow processes applied to the element 1 is, for example, two or more times. Note that, the thickness W of each of the thermistor layers 2a is not limited, but is preferably 5 to 100 μm. In this range, particularly, the variation in resistance is small, and thermal stability is improved.

For example, the thermistor element 1 according to the present embodiment is formed by applying a conductive paste containing Pd particles (external-electrode paste) onto both end surfaces of the element body 2 made of a ceramic body and baking the conductive paste. For example, the element body 2 can be manufactured by preparing a ceramic paste for the thermistor layers 2a and the protective layers 2b and an electrode paste for the internal electrode layers 3a and 3b, laminating the paste layers by a printing method, etc., and drying and sintering the paste layers.

Specifically, a thermistor element 1 is manufactured as follows.

First, a raw material of metals contained in metal oxide particles of a thermistor composition is prepared. In the present embodiment, the raw material is manganese oxide, nickel oxide, cobalt oxide, aluminum oxide, zirconium oxide, or a raw material that becomes these oxides after firing. Examples of compounds that become oxides after firing include carbonates, halides, oxalates, nitrates, hydroxides, and organometallic compounds containing these metals.

Next, the raw material is weighed and mixed to prepare a mixed powder. The mixing method is not limited and may be, for example, dry mixing, or wet mixing by adding water, an organic solvent, etc. to the mixed powder and using a ball mill, etc.

Next, the prepared mixed powder is granulated. The granulation is carried out so as to convert the mixed powder into agglomerated particles having suitable sizes and into a form suitable for molding. Examples of granulation methods include pressure granulation and spray drying. The spray drying method is a method in which a normally used binder, such as polyvinyl alcohol, is added to the mixed powder, and the mixture is thereafter atomized and dried in a spray dryer. Preferably, the mixed powder (thermistor composition raw material) as granules has an average particle size of 50 μm or less.

Then, the granules are mixed with water and a dispersant in a ball mill, and a binder resin is further added to obtain a ceramic slurry. The ceramic slurry is molded by a doctor blade method to obtain green sheets each having a thickness of about 5 to 100 μm.

A noble metal powder and an organic vehicle are mixed to prepare an internal-electrode paste. Preferably, the noble metal powder has an average particle size of 0.1 μm or more and 5.0 μm or less. Preferably, the internal-electrode paste contains a predetermined weight percent of the noble metal powder and a predetermined weight percent of the organic vehicle. The organic vehicle can be prepared, for example, by dissolving ethyl cellulose in terpineol.

The internal-electrode paste is printed on the green sheets in a predetermined shape to form an internal electrode pattern. A predetermined number of green sheets with the internal electrode pattern and green sheets without the internal electrode pattern are laminated in a predetermined order and pressurized to obtain a mother laminate. This mother laminate is cut to a predetermined size to obtain a chip-shaped laminate.

Next, or in parallel with the above process, a Pd powder, a glass frit, and the organic vehicle are kneaded to prepare an external-electrode paste. The Pd powder may be a mixture of a spherical Pd powder and a flat Pd powder. The glass frit is, for example, a glass frit containing B. The glass frit preferably has a transition point of 400° C. or more and 650° C. or less and a softening point of 500° C. or more and 750° C. or less.

The organic vehicle can be prepared, for example, by dissolving an acrylic resin in terpineol. The amount of the acrylic resin in the organic vehicle may be, for example, 5% by weight or more and 40% by weight or less.

The external-electrode paste is applied in a predetermined shape to one end surface and the other end surface of an element body 2 as a sintered body. The applied external electrodes may be dried. The application thickness of the external-electrode paste can be appropriately determined according to the desired thickness of the external electrodes.

The external-electrode paste applied to one end surface and the other end surface of the ceramic body is baked to form a first external electrode 4 disposed on one end surface and a second external electrode 4 disposed on the other end surface.

If necessary, a plating layer may be formed on the surfaces of the external electrodes 4 by electrolytic plating. The plating layer has a function of improving solder wettability and heat resistance during mounting. The composition of the plating layer can be appropriately selected according to the composition of the external electrodes, etc. For example, a Ni plating layer may be formed on the surfaces of the external electrodes 4, and a Sn plating layer may be formed thereon.

The present invention is not limited to the above-described embodiment and may be variously modified within the scope of the present invention.

For example, the NTC thermistor composition according to the above-described embodiment is suitable for use as the thermistor layers 2a of a multilayer chip type thermistor element, but can also be used as the composition for other types of thermistor elements. The NTC thermistor composition according to the above-described embodiment can be used for other types of NTC thermistor elements, such as glass diode type thermistors, glass bead type thermistors, and resin bead type thermistors.

### EXAMPLES

Hereinafter, the present invention is described with reference to more detailed examples, but the present invention is not limited to these examples.

### Examples 1 to 6

First, commercially available manganese tetroxide (Mn₃O₄), nickel oxide, cobalt oxide, and aluminum oxide were weighed and prepared as starting materials so that the compositions after firing would be those shown in Table 1. Note that, in Table 1, the mol % of Mn, Ni, Co, and Al is 100 mol % in total for Mn, Ni, Co, and Al. These raw materials were mixed and wet-mixed in a ball mill for 16 hours. Note that, these starting materials may contain 0.1% or less by weight of unavoidable impurities.

Next, the starting materials after the wet mixing were dehydrated, dried, and powdered using a mortar and pestle. Then, the powder obtained was placed in an alumina sagger and calcined at 800 to 1200° C. for 2 hours.

Next, the calcined powder obtained was finely pulverized in a ball mill and thereafter dehydrated and dried to obtain granules of thermistor composition raw material. The granules were mixed with water and a dispersant in a ball mill, and a binder resin was further added to obtain a ceramic slurry. This ceramic slurry was formed by a doctor blade method to obtain green sheets each having a predetermined thickness.

An internal-electrode paste was prepared by mixing a Pd powder as a noble metal powder with an organic vehicle. The average particle size of the noble metal powder was 0.5 μm. The internal-electrode paste was formed by dispersing the noble metal powder in the organic vehicle. The organic vehicle was prepared by dissolving ethyl cellulose in terpineol.

The internal-electrode paste was printed on the green sheets in a predetermined shape to form an internal-electrode pattern. A predetermined number of green sheets with the internal-electrode pattern and green sheets without the internal-electrode pattern were laminated in a predetermined order and pressurized to obtain a mother laminate. This mother laminate was cut to a predetermined size to obtain a chip-shaped laminate.

Next, or in parallel with the above process, a Pd powder, a glass frit, and an organic vehicle were kneaded to prepare an external-electrode paste. The Pd powder was a mixture of a spherical Pd powder and a flat Pd powder. The glass frit was a glass frit containing B, for example. The transition point of the glass frit was 520° C., and the softening point of the glass frit was 580° C.

The organic vehicle was prepared by, for example, dissolving an acrylic resin in terpineol. The amount of the acrylic resin in the organic vehicle was 30% by weight.

The external-electrode paste was applied in a predetermined shape to one end surface and the other end surface of an element body 2 as a sintered body. The applied external electrodes were dried. The external-electrode paste applied to one end surface and the other end surface of the ceramic body was baked to form a first external electrode 4 disposed on one end surface and a second external electrode 4 disposed on the other end surface. A Ni plating layer was formed on the surfaces of the external electrodes 4 by electrolytic plating, and a Sn plating layer was formed thereon. Accordingly, samples of a NTC thermistor element 1 were manufactured.

The evaluations shown in Table 1 were carried out for each sample. A process of placing a sample of the NTC thermistor element 1 in a reflow oven at a temperature of 260° C. for about 10 minutes and then cooling the sample was repeated six times, and the resistance change rate is a rate of change in the resistance value of the sample after six reflow processes relative to the resistance value of the sample before it was placed in the reflow furnace. The symbol A for the resistance change rate in Table 1 indicates that the rate of change in the resistance value of a sample after six reflow processes is within +0.5% relative to the resistance value of the sample before it was first placed in the reflow furnace.

Regarding the coefficient of variation of resistance value, 30 samples of each of the NTC thermistor elements of Examples 1 to 6 were prepared, and the variation in resistance value between the samples at 25° C. (CV value) was measured so as to determine the extent to which the CV value changed compared to the CV value in Example 1. The symbol F indicates that the CV value was 2.0 or more larger than that of Example 1, the symbol A indicates that the CV value was 1.4 or more and less than 2.0, the symbol A2 indicates that the CV value was 1.1 or more and less than 1.4, and the symbol A3 indicates that the CV value was less than 1.1.

In the determination, the case where the resistance change rate is A and the coefficient of variation of resistance value is A3 is determined to be A3, the case where the resistance change rate is A and the coefficient of variation of resistance value is A2 is determined to be A2, the case where the resistance change rate is A and the coefficient of variation of resistance value is A is determined to be A, and the case where the resistance change rate is F or the coefficient of variation of resistance value is F is determined to be F.

These results are shown in Table 1. Cross-sectional photographs of the thermistor layers of the samples of the element 1 according to Examples 1 to 6 were taken with a scanning electron microscope, and particles were analyzed by X-ray diffraction, confirming that the particles were spinel-type oxide particles. The average particle size of the particles was found to be 10 μm or less.

### Comparative Example 1

Except for preparing a starting material so that the Al content was 7.3 mol %, which is more than 5.9 mol %, as shown in Table 1, samples of an element were produced in the same manner as in Example 1, and tests and evaluations were performed in the same manner as in Example 1. The results are shown in Table 1.

### Evaluation 1

As shown in Table 1, it was confirmed that, compared to the samples according to Comparative Example 1 (the Al content is more than 5.9 mol %), both of the resistance change rate and the coefficient of variation of resistance value were favorable in Examples 1 to 6.

TABLE 1

| | | | | | | Coefficient | |
|---|---|---|---|---|---|---|---|
| | | | | | | of | |
| | | | | | | Variation | |
| | Composition | | | | Resistance | of | |
| | mol % | | | | Change | Resistance | Determin- |
| | Mn | Co | Ni | Al | Rate | Value | ation |
| Ex. 1 | 58.8 | 16.0 | 25.2 | 0 | A | A3 | A3 |
| Ex. 2 | 58.2 | 15.8 | 24.9 | 1.1 | A | A3 | A3 |
| Ex. 3 | 57.3 | 15.6 | 24.5 | 2.6 | A | A3 | A3 |
| Ex. 4 | 56.6 | 15.4 | 24.3 | 3.7 | A | A3 | A3 |
| Ex. 5 | 55.9 | 15.2 | 24.0 | 4.9 | A | A3 | A3 |
| Ex. 6 | 55.3 | 15.1 | 23.7 | 5.9 | A | A3 | A3 |
| Comp. | 54.5 | 14.8 | 23.4 | 7.3 | F | F | F |
| Ex. 1 | | | | | | | |

### Examples 7 to 12 and Comparative Examples 2 and 3

Except for preparing the starting materials so that: the Al content was 2.6 mol %; the Mn content was varied in the range of 36.5 to 66.1 mol %; and the Co content and the Ni content were varied accordingly, as shown in Table 2, samples of an element were produced in the same manner as in Example 3, and tests and evaluations were performed in the same manner as in Example 3. The results are shown in Table 2.

### Evaluation 2

As shown in Table 2, it was confirmed that, compared to the samples according to Comparative Examples 2 and 3 (the Mn content is outside the range of 40 to 63 mol %), both of the resistance change rate and the coefficient of variation of resistance value were favorable in Examples 7 to 12 (the Mn content is in the range of 40 to 63 mol %). It was also confirmed that the coefficient of variation of resistance value was more favorable in Examples 9 to 11 (the Mn content is in the range of 47 to 60 mol %).

TABLE 2

| | | | | | | Coefficient | |
|---|---|---|---|---|---|---|---|
| | | | | | | of | |
| | | | | | | Variation | |
| | Composition | | | | Resistance | of | |
| | mol % | | | | Change | Resistance | Determin- |
| | Mn | Co | Ni | Al | Rate | Value | ation |
| Comp. | 36.5 | 23.7 | 37.2 | 2.6 | F | A | F |
| Ex. 2 | | | | | | | |
| Ex. 7 | 40.2 | 22.2 | 35.0 | 2.6 | A | A | A |
| Ex. 8 | 44.3 | 20.6 | 32.5 | 2.6 | A | A | A |
| Ex. 9 | 47.1 | 19.5 | 30.8 | 2.6 | A | A2 | A2 |
| Ex. 10 | 52.0 | 17.6 | 27.8 | 2.6 | A | A2 | A2 |
| Ex. 3 | 57.3 | 15.6 | 24.5 | 2.6 | A | A3 | A3 |
| Ex. 11 | 59.7 | 14.6 | 23.1 | 2.6 | A | A2 | A2 |
| Ex. 12 | 62.5 | 13.6 | 21.3 | 2.6 | A | A | A |
| Comp. | 66.1 | 12.2 | 19.1 | 2.6 | F | A | F |
| Ex. 3 | | | | | | | |

### Examples 13 to 18 and Comparative Examples 4 and 5

Except for preparing the starting materials so that: the Al content was 4.9 mol %; the Ni content was varied in the range of 12.0 to 39.0 mol %; and the Mn content and the Co content were varied accordingly, as shown in Table 3, samples of an element were produced in the same manner as in Example 5, and tests and evaluations were performed in the same manner as in Example 5. The results are shown in Table 3.

### Evaluation 3

As shown in Table 3, it was confirmed that, compared to the samples according to Comparative Examples 4 and 5 (the Ni content is outside the range of 15 to 35 mol %), both of the resistance change rate and the coefficient of variation of resistance value were favorable in Examples 13 to 18 (the Ni content is in the range of 15 to 35 mol %). It was also confirmed that the coefficient of variation of resistance value was more favorable in Examples 14 to 17 (the Ni content is in the range of 17 to 31 mol %). It was also confirmed that the coefficient of variation of resistance value was more favorable in Examples 15 to 16 (the Ni content is in the range of 21 to 27 mol %).

TABLE 3

| | | | | | | Coefficient | |
|---|---|---|---|---|---|---|---|
| | | | | | | of | |
| | | | | | | Variation | |
| | Composition | | | | Resistance | of | |
| | mol % | | | | Change | Resistance | Determin- |
| | Mn | Co | Ni | Al | Rate | Value | ation |
| Comp. | 65.3 | 17.8 | 12.0 | 4.9 | F | A | F |
| Ex. 4 | | | | | | | |
| Ex. 13 | 62.9 | 17.1 | 15.1 | 4.9 | A | A | A |
| Ex. 14 | 61.2 | 16.6 | 17.3 | 4.9 | A | A2 | A2 |
| Ex. 15 | 58.2 | 15.8 | 21.1 | 4.9 | A | A3 | A3 |
| Ex. 5 | 55.9 | 15.2 | 24.0 | 4.9 | A | A3 | A3 |
| Ex. 16 | 53.7 | 14.6 | 26.8 | 4.9 | A | A3 | A3 |
| Ex. 17 | 50.5 | 13.8 | 30.8 | 4.9 | A | A2 | A2 |
| Ex. 18 | 47.4 | 12.9 | 34.8 | 4.9 | A | A | A |
| Comp. | 44.1 | 12.0 | 39.0 | 4.9 | F | A | F |
| Ex. 5 | | | | | | | |

### Examples 19 to 25 and Comparative Examples 6 and 7

Except for preparing the starting materials so that: the Al content was 3.7 mol %; the Co content was varied in the range of 8.1 to 32.3 mol %; and the Mn content and the Ni content were varied accordingly, as shown in Table 4, samples of an element were produced in the same manner as in Example 4, and tests and evaluations were performed in the same manner as in Example 4. The results are shown in Table 4.

### Evaluation 4

As shown in Table 4, it was confirmed that, compared to the samples according to Comparative Examples 6 and 7 (the Co content is outside the range of 10 to 30 mol %), both of the resistance change rate and the coefficient of variation of resistance value were favorable in Examples 19 to 25 (the Co content is in the range of 10 to 30 mol %). It was also confirmed that the coefficient of variation of resistance value was more favorable in Examples 20 to 23 (the Co content is in the range of 13 to 25 mol %). It was also confirmed that the coefficient of variation of resistance value was more favorable in Examples 4 and 21 to 22 (the Co content is in the range of 15 to 23 mol %).

As shown in Table 1 to Table 4, it was also confirmed that, compared to Examples in which the Ni content is smaller than the Co content, the coefficient of variation of resistance value was favorable in Examples in which the Ni content is larger than the Co content.

TABLE 4

| | | | | | | Coefficient | |
|---|---|---|---|---|---|---|---|
| | | | | | | of | |
| | | | | | | Variation | |
| | Composition | | | | Resistance | of | |
| | mol% | | | | Change | Resistance | Determin- |
| | Mn | Co | Ni | Al | Rate | Value | ation |
| Comp. | 61.7 | 8.1 | 26.5 | 3.7 | F | A | F |
| Ex. 6 | | | | | | | |
| Ex. 19 | 60.2 | 10.3 | 25.8 | 3.7 | A | A | A |
| Ex. 20 | 58.2 | 13.1 | 25.0 | 3.7 | A | A2 | A2 |
| Ex. 4 | 56.6 | 15.4 | 24.3 | 3.7 | A | A3 | A3 |
| Ex. 21 | 54.2 | 18.9 | 23.2 | 3.7 | A | A3 | A3 |
| Ex. 22 | 51.9 | 22.1 | 22.3 | 3.7 | A | A3 | A3 |
| Ex. 23 | 50.0 | 24.9 | 21.4 | 3.7 | A | A2 | A2 |
| Ex. 24 | 48.2 | 27.5 | 20.6 | 3.7 | A | A | A |
| Ex. 25 | 46.6 | 29.8 | 20.0 | 3.7 | A | A | A |
| Comp. | 44.8 | 32.3 | 19.2 | 3.7 | F | A | F |
| Ex. 7 | | | | | | | |

### Examples 2a to 2b and 6a and 6b

Except for preparing the starting materials so that: the Al content was varied as shown in Table 5; and Fe or Cu was contained, samples of an element were produced in the same manner as in Example 2 or 6, and tests and evaluations were performed in the same manner as in Example 2 or 6. The results are shown in Table 5.

### Evaluation 5

As shown in Table 5, it was confirmed that when Fe or Cu was contained, the coefficient of variation of resistance value was worse than that when Fe or Cu was not contained.

TABLE 5

| | | | | | | | | Coefficient of | |
|---|---|---|---|---|---|---|---|---|---|
| | | | | | Fe/ | Cu/ | Resistance | Variation of | |
| | Composition mol % | | | | (Mn + Co + | (Mn + Co + | Change | Resistance | |
| | Mn | Co | Ni | Al | Ni + Al) | Ni + Al) | Rate | Value | Determination |
| Ex. 2 | 58.2 | 15.8 | 24.9 | 1.1 | — | — | A | A3 | A3 |
| Ex. 6 | 55.3 | 15.1 | 23.7 | 5.9 | — | — | A | A3 | A3 |
| Ex. 2a | 58.4 | 16.0 | 25.0 | 0.6 | 0.5 | — | A | A | A |
| Ex. 2b | 58.4 | 16.0 | 25.0 | 0.6 | — | 0.5 | A | A | A |
| Ex. 6a | 55.6 | 15.1 | 23.9 | 5.4 | 0.5 | — | A | A | A |
| Ex. 6b | 55.6 | 15.1 | 23.9 | 5.4 | — | 0.5 | A | A | A |

### Comparative Examples 8 to 9

Except for preparing the starting materials so that: the Mn content, the Co content, the Ni content, and the Al content were varied as shown in Table 6; and Fe or Cu was contained or not contained, samples of an element were produced in the same manner as in Example 3, and tests and evaluations were performed in the same manner as in Example 3. The results are shown in Table 6.

### Evaluation 6

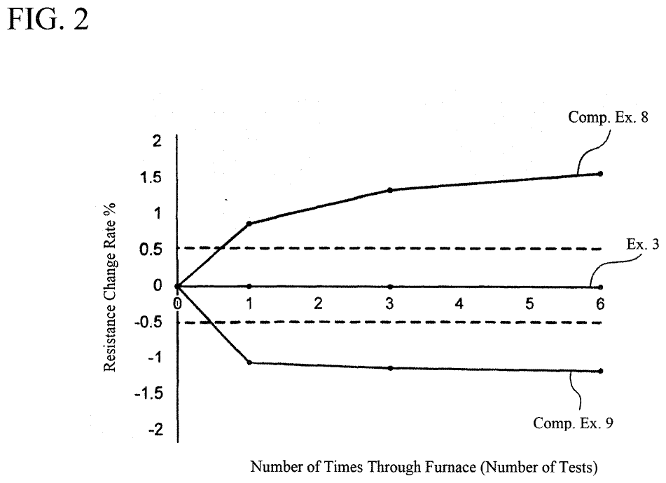

As shown in Table 6, it was confirmed that when Co was not contained, the resistance change rate was bad, and the coefficient of variation of resistance value was bad, regardless of whether Fe and Cu were contained. Note that, the graph of FIG. 2 shows the relation between the number of times through the furnace and the resistance change rate for the samples of Comparative Examples 8 and 9. Also, the graph of FIG. 2 shows the relation between the number of times through the furnace and the resistance change rate for the samples of Example 3.

TABLE 6

| | | | | | | | | Coefficient of | |
|---|---|---|---|---|---|---|---|---|---|
| | | | | | Fe/ | Cu/ | Resistance | Variation of | |
| | Composition mol % | | | | (Mn + Co + | (Mn + Co + | Change | Resistance | |
| | Mn | Co | Ni | Al | Ni + Al) | Ni + Al) | Rate | Value | Determination |
| Ex. 3 | 57.3 | 15.6 | 24.5 | 2.6 | — | — | A | A3 | A3 |
| Comp. | 73.0 | — | 16.0 | 11.0 | — | — | F | F | F |
| Ex. 8 | | | | | | | | | |
| Comp. | 82.6 | — | 17.4 | — | 14.0 | 2.3 | F | F | F |
| Ex. 9 | | | | | | | | | |

### Examples 26 to 29

Except for preparing the starting materials so that: the Al content was varied as shown in Table 7; and Zr was contained instead, samples of an element were produced in the same manner as in Example 3, and tests and evaluations were performed in the same manner as in Example 3. The results are shown in Table 7.

### Evaluation 7

As shown in Table 7, it was confirmed that when Zr was contained, the resistance change rate was equivalent to that when Zr was not contained, and Zr may be added up to 2.5 mol %.

TABLE 7

| | | | | | | | Coefficient of | |
|---|---|---|---|---|---|---|---|---|
| | | | | | Zr/ | Resistance | Variation of | |
| | Composition mol % | | | | (Mn + Co + | Change | Resistance | |
| | Mn | Co | Ni | Al | Ni + Al) | Rate | Value | Determination |
| Ex. 3 | 57.3 | 15.6 | 24.5 | 2.6 | 0 | A | A3 | A3 |
| Ex. 26 | 57.9 | 15.7 | 24.8 | 1.6 | 1.0 | A | A3 | A3 |
| Ex. 27 | 58.2 | 15.8 | 24.9 | 1.1 | 1.5 | A | A3 | A3 |
| Ex. 28 | 58.4 | 15.9 | 25.1 | 0.6 | 2.0 | A | A3 | A3 |
| Ex. 29 | 58.7 | 16.0 | 25.2 | 0.1 | 2.5 | A | A3 | A3 |

### DESCRIPTION OF THE REFERENCE NUMERICAL

1 . . . NTC thermistor element
2 . . . element body
2a . . . thermistor layer
2b . . . protective layer
3 . . . internal electrode layer
3a . . . first internal electrode layer
3a1 . . . interrupted portion
3b . . . second internal electrode layer
3b1 . . . interrupted portion
4 . . . external electrode

What is claimed is:

1. An NTC thermistor composition comprising:
40 to 63 mol % of Mn;
10 to 30 mol % of Co;
15 to 35 mol % of Ni; and
5.9 mol % or less (including 0) of Al,
where a total of Mn, Co, Ni, and Al is 100 mol %.

2. The NTC thermistor composition according to claim 1, further comprising 0 to 2.5 mol % of Zr.

3. The NTC thermistor composition according to claim 1, wherein Ni is contained more than Co.

4. The NTC thermistor composition according to claim 1, wherein Fe or Cu is not substantially contained.

5. The NTC thermistor composition according to claim 1, comprising spinel-type metal oxide particles having an average particle size of 10 μm or less.

6. An NTC thermistor element comprising the NTC thermistor composition according to claim 1.

7. The NTC thermistor element according to claim 6, wherein
a length of the NTC thermistor element in a first axis direction is 0.6 mm or less, and
a length of the NTC thermistor element in a second axis direction is 0.3 mm or less.
